(19) United States
(12) Patent Application Publication
(10) Pub. No.: US 2012/0281679 A1
(43) Pub. Date: Nov. 8, 2012

(54) RACH communication in cellular system

(75) Inventors: Jianke Fan, (US); Seppo Alanärä, (US)

(73) Assignee: Renesas Mobile Corporation

(21) Appl. No.: 13/068,088

(22) Filed: May 2, 2011

(51) Int. Cl. H04W 74/08; H04W 72/14

(52) U.S. Cl. 370/336; 370/329

(57) ABSTRACT

A solution for sharing random access parameters is provided. A plurality of terminal devices shares the same random access parameters, e.g. the random access preamble sequence, and different transmission opportunities are assigned to the terminal devices. The different transmission opportunities are used to distinguish the terminal devices in the random access procedure.

### FIELD

The invention relates to the field of radio communications and, particularly, to employing random access transmissions in a cellular communication system.

### BACKGROUND

Modern cellular communication systems support several types of communications. A number of different types of data applications is increasing and, as a consequence, more versatility is required from the cellular systems. Such applications include machine-type communications in which two devices (machines) communicate directly over radio with each other under the control of the cellular system (the connection is controlled by the cellular system but no data is routed through the cellular system).

### BRIEF DESCRIPTION

According to an aspect of the present invention, there is provided a method comprising: assigning, by a network element of a cellular communication system, the same random access parameters concurrently to a plurality of terminal devices; and assigning a different random access transmission opportunity to said plurality of terminal devices so as to multiplex random access transmissions of said plurality of terminal devices, wherein the random access transmission opportunity identifies each one of the plurality of terminal devices using the same random access parameters.

According to another aspect of the present invention, there is provided a method comprising: employing shared random access parameters in a terminal device of a cellular communication system, wherein the same random access parameters are allocated simultaneously to at least one other terminal device; receiving a random access transmission opportunity allocation according to a defined opportunity and/or order for random access transmission, wherein the random access transmission opportunity is multiplexed with random access transmission opportunities of the at least one other terminal device utilizing said shared random access parameters, and wherein the random access transmission opportunity identifies the terminal device from the at least one other terminal device using the same random access parameters; and causing the terminal device to carry out a random access transmission according to the received random access transmission opportunity and by using said shared random access parameters.

According to another aspect of the present invention, there is provided an apparatus comprising means for carrying out any one of the above-described methods.

According to another aspect of the present invention, there is provided an apparatus comprising: at least one processor; and at least one memory including a computer program code, wherein the at least one memory and the computer program code are configured, with the at least one processor, to cause the apparatus to assign the same random access parameters concurrently to a plurality of terminal devices of a cellular communication system, and to assign different random access transmission opportunities to said plurality of terminal devices so as to multiplex random access transmissions of said plurality of terminal devices, wherein the random access transmission opportunity identifies each one of the plurality of terminal devices using the same random access parameters.

According to another aspect of the present invention, there is provided an apparatus comprising: at least one processor; and at least one memory including a computer program code, wherein the at least one memory and the computer program code are configured, with the at least one processor, to cause the apparatus to: employ shared random access parameters in a terminal device of a cellular communication system, wherein the same random access parameters are allocated simultaneously to at least one other terminal device; receive a random access transmission opportunity allocation according to a defined opportunity and/or order for random access transmission, wherein the random access transmission opportunity is multiplexed with random access transmission opportunities of the at least one other terminal device utilizing said shared random access parameters, and wherein the random access transmission opportunity identifies the terminal device from the at least one other terminal device using the same random access parameters; and cause the terminal device to carry out a random access transmission according to the received random access transmission opportunity and by using said shared random access parameters.

According to yet another aspect of the present invention, there is provided a computer program product embodied on a computer readable distribution medium, wherein the computer program product, when executed by a computer, causes the computer to carry out a computer process comprising: assigning the same random access parameters concurrently to a plurality of terminal devices of a cellular communication system; and assigning a different random access transmission opportunity to said plurality of terminal devices so as to multiplex random access transmissions of said plurality of terminal devices, wherein the random access transmission opportunity identifies each one of the plurality of terminal devices using the same random access parameters.

According to yet another aspect of the present invention, there is provided a computer program product embodied on a computer readable distribution medium, wherein the computer program product, when executed by a computer, causes the computer to carry out a computer process comprising: employing shared random access parameters in a terminal device of a cellular communication system, wherein the same random access parameters are allocated simultaneously to at least one other terminal device; receiving a random access transmission opportunity allocation according to a defined opportunity and /or order for random access transmission, wherein the random access transmission opportunity is multiplexed with random access transmission opportunities of the at least one other terminal device utilizing said shared random access parameters, and wherein the random access transmission opportunity identifies the terminal device from the at least one other terminal device using the same random access parameters; and causing the terminal device to carry out a random access transmission according to the received random access transmission opportunity and by using said shared random access parameters.

Embodiments of the invention are defined in the dependent claims.

### LIST OF DRAWINGS

Embodiments of the present invention are described below, by way of example only, with reference to the accompanying drawings, in which

FIG. 1 illustrates communication between a mobile terminal and a mobile telecommunication system;

FIG. 2 illustrates flow diagrams of methods for employing shared random access parameters according to an embodiment of the invention;

FIG. 3 illustrates time-indexing for use in discrimination of terminal devices sharing the same random access parameters according to an embodiment of the invention;

FIG. 4 illustrates random access parameter reuse according to an embodiment of the invention;

FIG. 5 is a signalling diagram of a random access procedure according to an embodiment of the invention;

FIGS. 6 to 8 illustrate embodiments for grouping terminal devices and assigning shared random access parameters to the groups; and

FIGS. 9 and 10 illustrate apparatuses according to embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

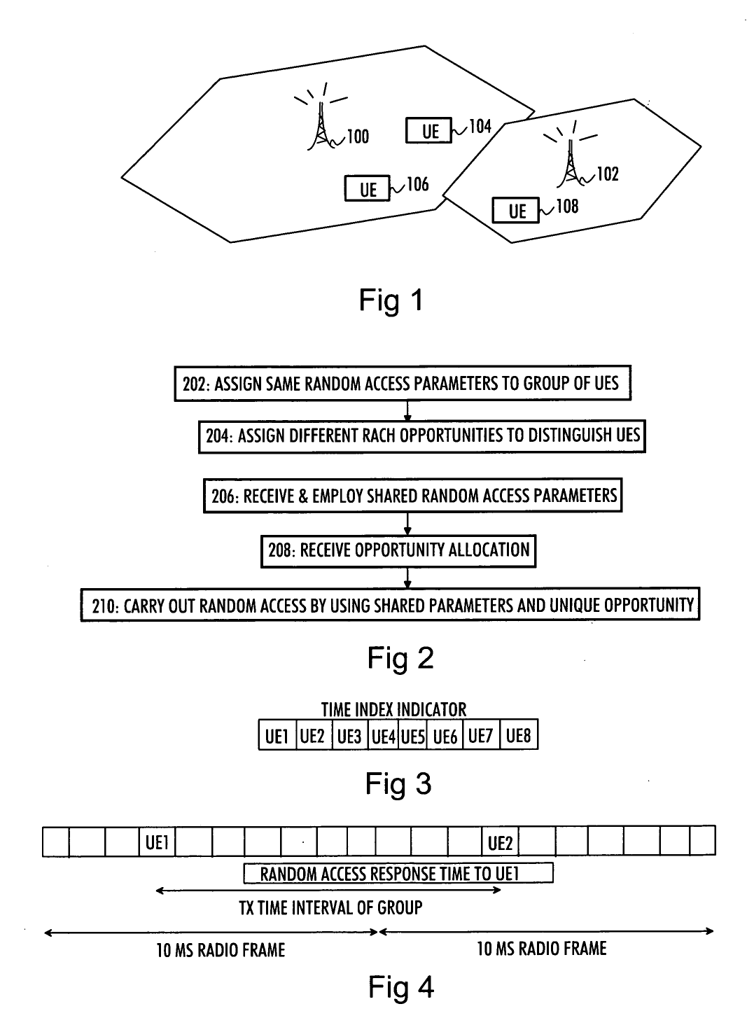

A general cellular communication scenario to which embodiments of the present invention may be applied is illustrated in FIG. 1. Referring to FIG. 1, a cellular communication system comprises a radio access network formed by a plurality of base stations 100, 102 (BS, also called Node B or evolved node B, eNB) that provide wireless communication services to terminal devices 104, 106, 108 (also known as user equipment, UE). Each base station 100, 102 controls a limited coverage area known as a cell. Some base stations may control even multiple cells (or sectors). The cellular communication system may be based on the Universal Mobile Telecommunication System (UMTS) or any one of its evolution versions (e.g. long-term evolution, LTE, or LTE-Advanced), a system based on International Mobile Telecommunication (IMT) standard or any one of its evolution versions (e.g. IMT-Advanced), Worldwide Interoperability for Microwave Access (WiMAX), IEEE 802.11-based network (e.g. IEEE 802.11n, 802.11af, or 802.11ac). However, the cellular system is not limited to these examples and it may be any other wireless network within the scope of the present claims.

When requesting data transmission, a terminal device 104 to 108 may carry out a random access procedure to request a serving base station 100, 102 to allocate transmission resources. Such random access procedure may be used to request transmission over a machine-to-machine (M2M) or device-to-device (D2D) connection established directly between two terminal devices 104 to 108. The M2M or D2D connection may consist of a radio link between the terminal devices 104 to 108, and the connection may be controlled by the serving base station. Other communication scenarios requiring random access naturally exist, and an increase in the number of random access occasions in a given cell results in increased utilization of random access resources, e.g. random access preambles that may be defined as a limited set of dedicated sequences transmitted in connection with the random access on a random access channel (RACH).

Some embodiments of the invention provide methods, apparatuses, and computer programs to optimize the utilization of the random access parameters. FIG. 2 illustrates an embodiment for configuring utilization of shared random access parameters. Referring to FIG. 2, a network element of the cellular communication system assigns in block 202 the same random access parameters concurrently to a plurality of terminal devices. The terminal devices may thus share the same random access parameters simultaneously.

In block 204, the network element assigns a different random access transmission opportunity to said plurality of terminal devices so as to multiplex random access transmissions of said plurality of terminal devices. Accordingly, the random access transmission opportunity enables identification of each one of the plurality of terminal devices using the same random access parameters.

Blocks 206 to 210 illustrate the operation of the terminal device. In block 206, the terminal device employs shared random access parameters, wherein the same random access parameters are allocated simultaneously to at least one other terminal device. In block 208, the terminal device receives a random access transmission resource allocation in terms of assigned random access transmission opportunity. The random access transmission opportunity is multiplexed with other random access transmission opportunities of terminal devices utilizing said shared random access parameters, and the random access transmission opportunity identifies the terminal device from the at least one other terminal device using the same random access parameters. In block 210, the terminal device carries out a random access transmission according to the received random access transmission resource allocation and by using said shared random access parameters.

Embodiments carrying out the process(es) of FIG. 2 enable sharing the same random access parameters concurrently, e.g. the random access preamble sequence, and at least some of time and frequency indexes. This reduces the consumption of limited random access preamble resources, e.g. the random access preamble sequences. The different terminal devices sharing the same random access parameters may, however, be identified by assigning different random access transmission opportunities to them. Thus, when each terminal device uses shared random access parameters but unique transmission opportunity, e.g. transmission timing, and/or transmission frequency, the base station receiving the random access transmission is able to identify the terminal device in the random access procedure.

In an embodiment, the random access transmission resource is transmission timing. The transmission timing may be defined by a transmission timing allocation parameters signalled by the radio access network to the terminal devices sharing the same random access parameters. The random access parameters may be defined by a random access radio network temporary identifier (RA-RNTI) assigned by the radio access network to each terminal device. The transmission timing allocation parameters may include a transmission order index (TimeIndexIndicator) parameter and a random access transmission interval (TTInterval) parameter. The transmission order index may define an order in which the terminal devices are assigned to have an opportunity to carry out the random access transmission, and each terminal device sharing the same random access parameters may be assigned with a different transmission order index through bitmapping. FIG. 3 illustrates en embodiment of the transmission order index parameter where the order of the terminal devices sharing the same random access parameters are illustrated. The random access transmission interval parameter may define a periodicity for the random access opportunity of the group. The random access transmission interval parameter may thus be shared within the group (the same for each terminal device in the group). Let us assume that the number of terminal devices in the group is 8 (as in FIG. 3) and that the random access transmission interval parameter is the length of the radio frame, e.g. 10 ms. The random access transmission interval may be signalled by the base station to the terminal device. However, in other embodiments the terminal devices are configured to use a fixed default value (e.g. the length of the radio frame, 10 ms) and, thus, signalling overhead is reduced. Additionally, a terminal device may carry out the random access transmission at a given physical random access channel (PRACH) configuration, a time and a frequency resources (defined by corresponding indexes) defined by the serving base station or, in general, the radio access network. The time index can be a default “the first sub-frame” of the selected PRACH configuration or a specific number of the sub-frame in the PRACH configuration. A given terminal device having a transmission order index defining that the terminal device has an opportunity to transmit in that first sub-frame or at one subsequent sub-frame, may carry out the random access transmission in that sub-frame. Other terminal devices of the group wait for their turn. After the time period specified by the random access transmission interval parameter has passed from the subframe used by the first terminal device, the second terminal device in the order has the opportunity for the random access. Similarly, the process continues such that each terminal device of the group has the random access opportunity in turn. When all the terminal devices have had the random access opportunity and after the period from the opportunity of the last terminal device has expired, the first terminal device gains the second random access opportunity. Accordingly, a given terminal device of the group has random access opportunities with a periodicity defined by the random access transmission interval multiplied by the number of terminal devices in the group.

FIG. 4 illustrates reuse of the same random access parameters in the form of a timeline. A first terminal device carries out a random access in a sub-frame indicated by “UE1” in FIG. 4. The random access transmission is carried out according to the transmission timing received from the serving base station. The random access transmission is followed by a random access response time, wherein the random access response time may start after a determined period from the random access transmission, e.g. in a conventional LTE system the random access response time is started at the n+3 after random access transmission at sub-frame n. The window of the response time is 10 ms during which the terminal device monitors for a random access response from the base station. If it receives no random access response within the random access response time, it carries out the random access transmission again in the next opportunity. In a conventional system, the same random access parameters cannot be reused by multiple terminal devices during the random access response time, because if the same RA-RNTI and preamble is used, it will lead into collision and only one of colliding terminal devices may get its random access confirmed in the response message. However, in some embodiments of the invention, as the different terminal devices utilizing the same random access parameters may be distinguished according to their random access timing, a second terminal device sharing the same random access parameters (e.g. the random access preamble sequence) may carry out the random access transmission in a sub-frame (“UE2” in FIG. 4) that is within the random access response time of the first terminal device.

When the periodicity defined by the random access transmission interval is the same as the length of the radio frame, the group sharing the same random access parameters may have an opportunity for the random access in the same sub-frame in each radio frame. The random access is in some embodiments contention-based, while in other embodiments, the random access is free of contention. The contention-free scheme has the advantage that the random access collisions are avoided.

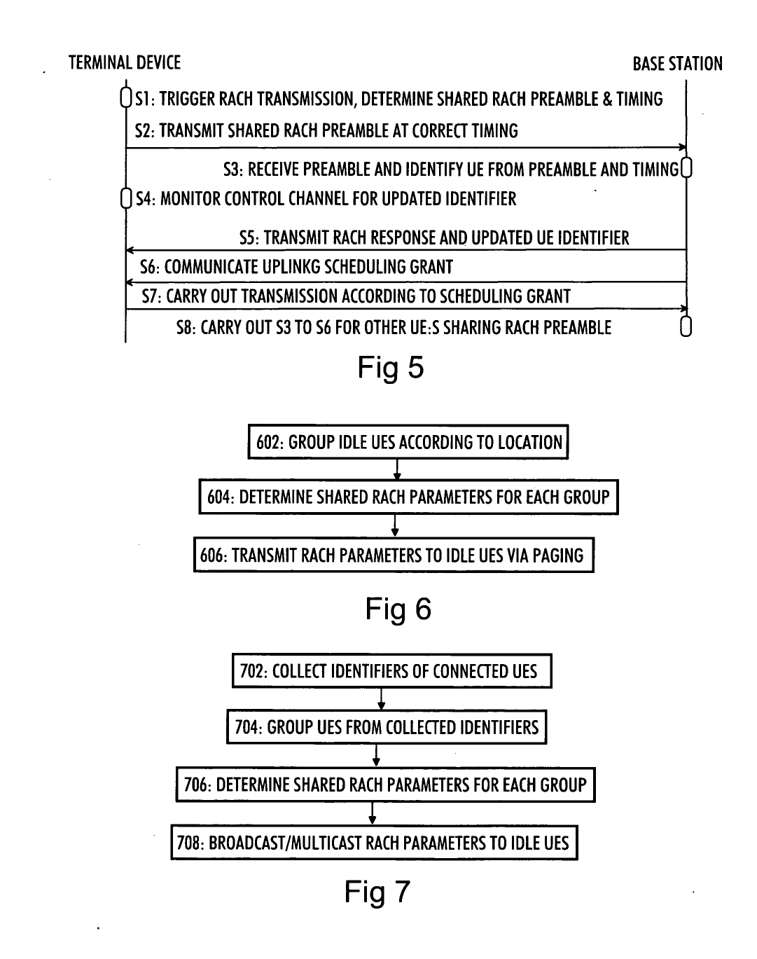

FIG. 5 illustrates a random access procedure between a terminal device 104 to 108 and a serving base station 100, 102. The terminal device shares the same random access parameters with at least one other terminal device and, thus, the random access parameters are shared within a group of terminal devices. The principal behind the group sharing of random access parameters is that the terminal devices are grouped into several small groups, and the random access parameters may be signalled to the group of terminal devices by using broadcasting, paging channel, or Medium Access Control (MAC)/Radio Resource Control (RRC) signalling. Different shared random access parameters may be sent to the terminal devices in each group separately. New set of group-shared random access parameters may be transmitted on a broadcasting, paging, or Multimedia Broadcast Multicast Service (MBMS) channel for terminal devices that are in an idle state. The shared random access parameters may be transmitted to terminal devices that are in a connected state by using a MAC or RRC signalling channel.

Referring to FIG. 5, a random access transmission is triggered in the terminal device in S1. A physical layer random access may be triggered upon request of a random access preamble transmission originated from higher layers in the terminal device. In response to such a request, the terminal device determines the random access parameters comprising a random access preamble, a corresponding RA-RNTI, physical random access channel (PRACH) resources, and the transmission timing which may be defined by the above-mentioned Time Index Indicator and TTInterval (although other means for determining the transmission timing of the random access transmission may be used). The transmission timing parameters may be defined in the RA-RNTI that is assigned by the radio access network. The terminal device may also determine in S1 transmission power of the random access transmission on the basis of estimated path loss and other transmission power parameters. The random access preamble sequence may be selected from a preamble sequence set by using a preamble index provided by the radio access network as the random access parameter, and the preamble index may be shared concurrently by the group of terminal devices.

In S2, the terminal device carries out the random access transmission by transmitting the random access preamble sequence on the PRACH at the timing assigned by the radio access network, as described above. In S3, the serving base station receives the random access preamble sequence and identifies the terminal device from the preamble sequence and the timing used for transmitting the preamble sequence. The base station naturally knows the random access parameters and timings assigned to different terminal devices, so the identification is straightforward. In order to identify the terminal device from the other terminal devices sharing the same RA-RNTI, the base station may update the RA-RNTI of the terminal device by inserting the transmission order index of the terminal device to the RA-RNTI of the terminal device, thus resulting in identifier denoted by NRA-RNTI. Now, the terminal device may be identified from the other terminal devices sharing the same RA-RNTI. After transmitting the random access transmission, the terminal device may be configured to monitor for a control channel, e.g. a physical downlink control channel (PDCCH), for a control message comprising the updated identifier NRA-RNTI. The duration for carrying out the monitoring of the control channel (the random access response time) may be predefined by the higher layers, for example. Then, the base station may transmit a random access response message comprising the updated identifier NRA-RNTI on the control channel in S5. If the control message carrying the updated identifier NRA-RNTI is detected by the terminal device on the control channel (S6), a transport block on a corresponding data channel, e.g. physical downlink shared channel (PDSCH), is received by the terminal device and forwarded to higher layers. The higher layers may extract the transport block, and if the transport block contains an uplink scheduling grant message, the terminal device is configured to carry out a data transmission on uplink transmission resources in S7 as specified in the scheduling grant message. The transmission may be an uplink transmission, or it may be a D2D transmission.

In S8, the base station carries out steps S3 to S6 for the other terminals sharing the same random access parameters as the terminal device discussed. The execution of steps S3 to S6 is repeated with a periodicity defined by the transmission timing periodicity parameter. If a terminal device does not take the random access opportunity, or fails to do so, the base station then omits the execution of steps S3 to S6 for that period. The terminal device and the base station may then wait for the next opportunity, or the base station may assign new random access parameters and/or transmission timing to the terminal device that missed the random access opportunity.

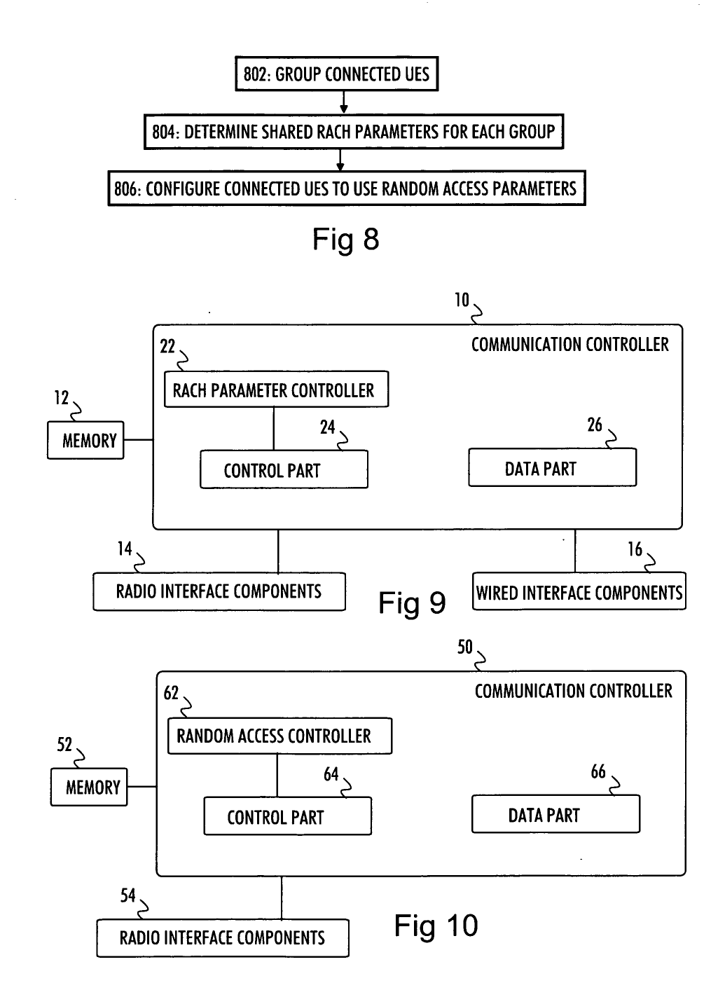

Let us now describe embodiments for grouping the terminal devices into groups and for allocating the same random access parameters to the terminal devices belonging to the same group. FIGS. 6 to 8 illustrate processes for grouping the terminal devices and signalling the random access parameters. FIGS. 6 and 7 illustrate grouping of idle state terminal devices, and FIG. 8 illustrates grouping of connected state terminal devices. The idle state relates to a state where the terminal device does not have an RRC connection with the radio access network, and the connected state relates to a state where the terminal device has the RRC connection with the radio access network.

When terminal device has been switched on and it is camping in an idle state in a cell, the terminal device is currently identified by a Temporary Mobile Subscriber Identity (TMSI) which is an identifier on a non-access stratum (NAS) level. A mobility management entity (MME) controlling mobility of terminal devices on a larger area covering several cells uses the TMSI as an identifier for paging purposes. A base station is simply forwarding paging information to the terminal devices, as necessary, but it may not be aware of TMSIs as identifiers. The MME may be a network element of a core network of the cellular communication system. The location of the terminal device may thus be known by the MME on a Tracking Area (TA) granularity. The tracking area may comprise multiple base stations. According to an embodiment, the terminal devices are grouped by the MME (or the base station or another network element) on the basis of their location within the tracking area. The terminal devices in the same tracking area may be grouped together, and multiple groups for a given tracking area may naturally be formed (block 602 in FIG. 6).

In block 604, the network element determines the random access parameters for each group, e.g. the shared random access preamble and the transmission resources to identify the terminal devices sharing the same preamble. In connection with the terminal device communicating with the radio access network in the idle state, the radio access network may assign the terminal device with a group identifier that may be stored in the terminal device. The group members may then be identified based on the group identifier which is stored in the terminals when in the idle state. The random access parameters may be signalled to the group of terminal devices in the connected state and, thus, the terminal devices may be paged by the NAS identity (TMSI). Then, the new random access parameters including the transmission timing allocation or another random access transmission resource allocation may be signalled to the terminal devices in block 606.

If multiple groups are assigned, the groups may be orthogonalized by selecting different dedicated set of random access parameters for each group. This grouping may be carried out on the basis of the locations of the terminal devices in a larger area than a single cell or coverage area of a single base station. The grouping and determining the random access parameters may be carried out by the MME, or a given base station may retrieve from the MME the identifiers of the terminal devices in the tracking area and carry out the grouping and allocation of the random access parameters. In yet another embodiment, the MME carries out the grouping and the base station the allocation of the random access parameters.

Another embodiment uses a conventional random access procedure for the first radio access and, after the first access and before the next packet transmission, the base station stores connected state identifiers (C-RNTI) of the terminal devices. In other words, the base station collects identifiers (C-RNTIs) of the terminal devices that have been in the connected state with the base station in block 702 (FIG. 7). The base station then creates groups from the pool of collected identifiers in block 704 for the following packet transmission occasions. Accordingly, the grouping may now be made on a base station or cell level. The random access parameters and random access transmission resources are determined by the base station in block 706. After the connection establishment and associated identifier collection in block 702, at least some of the terminal devices may have already entered the idle state. In this embodiment, the base station may transmit the random access parameters and the random access transmission resource allocation to the idle state terminal devices, whose identifiers were collected in block 702, on a broadcasting channel or an MBMS channel (block 708). Security and authentication information of the terminal devices may be reset after the next successful RRC connection setup procedure. In this solution there is no need to carry out higher layer signalling between the MME and the base station. In some embodiments, this procedure of FIG. 7 is applied to terminal devices that the base station has determined to be stationary, e.g. by detecting their presence in the cell at least a determined time period. In other words, the grouping in block 704 may be applied only to those terminal devices that are determined to be stationary.

The group-sharing of random access parameters is also possible for terminal devices that are in the connected state in order to prevent overload and consumption of the random access parameter resources. The base station may identifiy the terminal devices. (including D2D devices) after their first-time power-up and access to the radio access network. Then, the base station (or another network element) may carry out the grouping of the terminal devices in block 802 and determine the shared random access parameters and the random access transmission resources in block 804. As the terminal devices are in the connected state, the random access parameters and the resource allocation may be signalled by using the MAC or RRC signalling (block 806). The terminal devices in the connected state are thus configured to request for transmission through the random access procedure. This may be applied to the D2D transmissions where the terminal devices request transmission over a D2D link through the random access procedure. It may, however, be applied to other scenarios.

The terminal devices may be in connected state and in a “dormant” state. The security and authentication information for such terminal devices may be stored in the MME. When a UE is in the “dormant” state, the operation of the terminal device is similar to the idle state, a difference is that the identifiers (C-RNTI) and context parameters related to the connection are still maintained in the base station for the fast transfer to an “active” state. There may be no need to carry out repeated channel quality indicator (CQI) reporting normally for the terminal devices in the dormant state. If necessary, the base station may request the temporary CQI reporting by including one bit in random access response message.

In some embodiments, the base station may be configured to change the random access parameters in periods defined by the random access transmission timing parameters. The random access parameters may be changed when every terminal device has had the same number of random access opportunities. Accordingly, the base station may be configured to monitor for the random access opportunity of the last terminal device in the order (UE8 in FIG. 3) and, after the random access opportunity of the last terminal device UE8, the base station may reconfigure at least some of the random access parameters for the subsequent period.

FIG. 9 illustrates an embodiment of an apparatus comprising means for carrying out the above-mentioned functionalities of the network element, e.g. the base station. The apparatus may be applicable to a cellular communication system described above and it may form part of the base station or another network element of such a system. In an embodiment, the apparatus is the base station. In another embodiment, the apparatus is comprised in such a network element, e.g. the apparatus may comprise a circuitry, e.g. a chip, a processor, a micro controller, or a combination of such circuitries in the network element and cause the network element to carry out the above-described functionalities.

The apparatus may comprise a communication controller circuitry 10 configured to control the communications in the apparatus. The communication controller circuitry 10 may comprise a control part 24 handling control plane signaling in a cell and/or other (higher layer) control plane signaling. For example, the control part 24 may control establishment, operation, and termination of cellular connections with terminal devices and carry out radio resource control procedures in the cell. The communication controller circuitry 10 may further comprise a data part 26 that handles transmission and reception of payload data with the terminal devices. The data part 26 may forward data received from the terminal devices towards the core network and data received from the core network to the terminal devices.

The apparatus may further comprise a random access controller circuitry 22 configured to carry out the grouping of the terminal devices and/or assigning random access parameters and the random access transmission resources to the terminal devices, as described above. The random access controller circuitry 22 may then transmit the assigned parameters and the resources to the terminal devices through the control part 24. The random access controller circuitry 22 may also communicate with other network elements in connection with grouping and/or assigning the random access parameters.

The circuitries 22 to 26 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 22 to 26 or all of them.

The apparatus may further comprise one or more memories 12 that store(s) computer programs (software) configuring the apparatus to perform the above-described functionalities of the apparatus. The memory 12 may also store communication parameters and other information needed for the wireless communications and/or to carry out the assignment of the random access resources. For example, the memory 12 may store a list, of random access preamble sequences and/or identifiers of the terminal devices to which the random access parameters may be assigned. The apparatus may further comprise radio interface components 14 providing the apparatus with radio communication capabilities with the terminal devices and/or other network nodes, e.g. with other base stations. The radio interface components 14 may comprise standard well-known components such as amplifier, filter, frequency-converter, (de)modulator, and encoder/decoder circuitries and one or more antennas. The apparatus may further comprise wired interface components 16 that may be configured to provide the apparatus with a wired connection to other elements of the cellular system, e.g. the core network, the MME, and the base stations forming the radio access network. The wired interface components 16 may realize an IP connection or an S1 connection used in the UMTS LTE networks, for example.

In an embodiment, the apparatus carrying out the embodiments of the invention for determining sharing of the random access parameters comprises at least one processor and at least one memory including a computer program code, wherein the at least one memory and the computer program code are configured, with the at least one processor, to cause the apparatus to carry out the steps of the network element in any one of the processes of FIGS. 2 to 8. Accordingly, the at least one processor, the memory, and the computer program code form processing means for carrying out embodiments of the present invention in the network element.

FIG. 10 illustrates an embodiment of an apparatus comprising means for carrying out the above-mentioned functionalities of the terminal device. The apparatus may be a terminal device of a cellular communication system, e.g. a computer (PC), a laptop, a tabloid computer, a cellular phone, a communicator, a smart phone, a palm computer, or any other communication apparatus. In another embodiment, the apparatus is applicable to such a terminal device, e.g. the apparatus may comprise a circuitry, e.g. a chip, a processor, a micro controller, or a combination of such circuitries in the terminal device.

The apparatus may comprise a communication controller circuitry 50 configured to control the communications in the apparatus. The communication controller circuitry 50 may comprise a control part 64 handling control plane signaling with a serving base station and, optionally, with other base stations or communication devices including other terminal devices in direct D2D connections. For example, the control part 64 may control establishment, operation, and termination of cellular connections with the cellular network and carry out radio resource control procedures in the terminal device under the control of the cellular network. The communication controller circuitry 50 may further comprise a data part 66 that handles transmission and reception of payload data with the cellular network and/or with other base stations or terminal devices. The data part 66 may forward data received from an application executed in the terminal device towards the cellular network and data received from the cellular network to the application.

The apparatus may further comprise a random access controller circuitry 62 configured to receive through the control part 64 random access parameters and associated random access transmission resources from the serving base station. The random access controller circuitry 62 is also configured to apply the random access parameters only in the assigned random access transmission resources, when the random access procedure is triggered as described above.

The circuitries 62 to 66 of the communication controller circuitry 50 may be carried out by the one or more physical circuitries or processors. In practice, the different circuitries may be realized by different computer program modules. Depending on the specifications and the design of the apparatus, the apparatus may comprise some of the circuitries 62 to 66 or all of them.

The apparatus may further comprise one or more memories 52 that stores computer programs (software) configuring the apparatus to perform the above-described functionalities of the terminal device. The memory 52 may also store communication parameters and other information needed for the wireless communications with the radio access network and/or with the other terminal devices. For example, the memory 52 may store the random access parameters and associated random access transmission resources. The apparatus may further comprise radio interface components 54 providing the apparatus with radio communication capabilities with the cellular network, other base stations, e.g. with femtocell base stations, and/or with other terminal devices over the direct D2D radio links. The radio interface components 54 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention for carrying out the random access by using shared random access parameters comprises at least one processor and at least one memory including a computer program code, wherein the at least one memory and the computer program code are configured, with the at least one processor, to cause the apparatus to carry out the steps of the terminal device in any one of the processes described in connection with FIGS. 2 to 8 from the point of view of the terminal device. Accordingly, the at least one processor, the memory, and the computer program code form processing means for carrying out embodiments of the present invention in the terminal device.

As used in this application, the term ‘circuitry’ refers to all of the following: (a) hardware-only circuit implementations, such as implementations in only analog and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a mobile phone or a similar integrated circuit in server, a cellular network device, or other network device.

The processes or methods described in FIGS. 4 to 8 may also be carried out in the form of a computer process defined by a computer program. The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to cellular or mobile telecommunication systems defined above but also to other suitable telecommunication systems. The embodiments are applicable to both frequency-division duplexed (FDD) and time-division duplexed (TDD) radio communications. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method, comprising:
assigning, by a network element of a cellular communication system, the same random access parameters concurrently to a plurality of terminal devices; and
assigning a different random access transmission opportunity to said plurality of terminal devices so as to multiplex random access transmissions of said plurality of terminal devices, wherein the random access transmission opportunity identifies each one of the plurality of terminal devices using the same random access parameters.

2. The method of claim 1, further comprising: assigning the same random access preamble sequence to said plurality of terminal devices.

3. The method of claim 1, wherein the random access transmission opportunity is a random access transmission timing allocation, the method further comprising:
assigning at least two terminal devices to transmit the same random access preamble within a random access response time window which defines a time period assigned for responding to a random access transmission.

4. The method of claim 1, further comprising:
determining the terminal devices to share the same random access parameters concurrently on the basis of location of the terminal devices such that the same random access parameters are assigned to a group of idle state terminal devices residing in the same determined location tracking area.

5. The method of claim 1, further comprising:
establishing a connection to a plurality of terminal devices;
in connection with the connection establishment, collecting identifiers of said plurality of connected terminal devices;
determining the terminal devices to share the same random access parameters concurrently from the collected identifiers; and
causing a base station of the cellular communication system to transmit the shared random access parameters in a form of connectionless signalling to at least one terminal device that has terminated said connection and entered an idle state.

6. The method of claim 1, further comprising:
establishing a connection to a plurality of terminal devices;
in connection with the connection establishment, collecting identifiers of said plurality of connected terminal devices;
determining the connected terminal devices to share the same random access parameters concurrently; and
configuring the connected terminal devices to employ the random access parameters and the random access transmission opportunity to request transmission in a connected state.

7. A method, comprising:
employing shared random access parameters in a terminal device of a cellular communication system, wherein the same random access parameters are allocated simultaneously to at least one other terminal device;
receiving a random access transmission opportunity allocation according to a defined opportunity and for order for random access transmission, wherein the random access transmission opportunity is multiplexed with random access transmission opportunities of the at least one other terminal device utilizing said shared random access parameters, and wherein the random access transmission opportunity identifies the terminal device from the at least one other terminal device using the same random access parameters; and
causing the terminal device to carry out a random access transmission according to the received random access transmission opportunity and by using said shared random access parameters.

8. The method of claim 7, wherein the shared random access parameters comprise a random access preamble sequence for random access transmission.

9. The method of claim 7, wherein the random access transmission opportunity is a random access transmission timing allocation, the method further comprising:
causing the terminal device to carry out the random access transmission with a transmission timing defined by the random access transmission timing allocation.

10. The method of claim 9, wherein the random access transmission timing allocation comprises a random access transmission order index parameter and a random access transmission interval parameter, wherein at least the random access transmission order index is different for each terminal device employing said shared random access parameters, the method further comprising:
causing the terminal device to carry out the random access transmission in transmission timings defined by the random access transmission order index parameter and the random access transmission interval parameter.

11. The method of claim 7, further comprising:
causing the terminal device to utilize a first random access identifier in connection with random access transmission;
causing the terminal device to update the random access identifier after the random access transmission; and
causing the terminal device to monitor for random access response message comprising said updated identifier, the random access response message being a response to said random access transmission.

12. An apparatus comprising:
at least one processor; and
at least one memory including a computer program code, wherein the at least one memory and the computer program code are configured, with the at least one processor, to cause the apparatus to assign the same random access parameters concurrently to a plurality of terminal devices of a cellular communication system, and to assign different random access transmission opportunities to said plurality of terminal devices so as to multiplex random access transmissions of said plurality of terminal devices, wherein the random access transmission opportunity identifies each one of the plurality of terminal devices using the same random access parameters.

13. The apparatus of claim 12, wherein the at least one memory and the computer program code are configured, with the at least one processor, to cause the apparatus to assign the same random access preamble sequence to said plurality of terminal devices.

14. The apparatus of claim 12, wherein the random access transmission opportunity is a random access transmission timing allocation, and wherein the at least one memory and the computer program code are configured, with the at least one processor, to cause the apparatus to assign at least two terminal devices to transmit the same random access preamble within a random access response time window which defines a time period assigned for responding to a random access transmission.

15. The apparatus of claim 12, wherein the at least one memory and the computer program code are configured, with the at least one processor, to cause the apparatus to determine the terminal devices to share the same random access parameters concurrently on the basis of location of the terminal devices such that the same random access parameters are assigned to a group of idle state terminal devices residing in the same determined location tracking area.

16. The apparatus of claim 12, wherein the at least one memory and the computer program code are configured, with the at least one processor, to cause the apparatus to:
establish a connection to a plurality of terminal devices;
in connection with the connection establishment, collect identifiers of said plurality of connected terminal devices;
determine the terminal devices to share the same random access parameters concurrently from the collected identifiers; and
cause a base station of the cellular communication system to transmit the shared random access parameters in a form of connectionless signalling to at least one terminal device that has terminated said connection and entered an idle state.

17. The apparatus of claim 12, wherein the at least one memory and the computer program code are configured, with the at least one processor, to cause the apparatus to:
establish a connection to a plurality of terminal devices;
in connection with the connection establishment, collect identifiers of said plurality of connected terminal devices;
determine the connected terminal devices to share the same random access parameters concurrently; and
configure the connected terminal devices to employ the random access parameters and the random access transmission opportunity to request transmission in a connected state.

18. An apparatus comprising:
at least one processor; and
at least one memory including a computer program code, wherein the at least one memory and the computer program code are configured, with the at least one processor, to cause the apparatus to:
employ shared random access parameters in a terminal device of a cellular communication system, wherein the same random access parameters are allocated simultaneously to at least one other terminal device;
receive a random access transmission opportunity allocation according to a defined opportunity and/or order for random access transmission, wherein the random access transmission opportunity is multiplexed with random access transmission opportunities of the at least one other terminal device utilizing said shared random access parameters, and wherein the random access transmission opportunity identifies the terminal device from the at least one other terminal device using the same random access parameters; and
cause the terminal device to carry out a random access transmission according to the received random access transmission opportunity and by using said shared random access parameters.

19. The apparatus of claim 18, wherein the shared random access parameters comprise a random access preamble sequence for random access transmission.

20. The apparatus of claim 18, wherein the random access transmission opportunity is a random access transmission timing allocation, and wherein the at least one memory and the computer program code are configured, with the at least one processor, to cause the apparatus to cause the terminal device to carry out the random access transmission with a transmission timing defined by the random access transmission timing allocation.

21. The apparatus of claim 20, wherein the random access transmission timing allocation comprises a random access transmission order index parameter and a random access transmission interval parameter, wherein at least the random access transmission order index is different for each terminal device employing said shared random access parameters, and wherein the at least one memory and the computer program code are configured, with the at least one processor, to cause the apparatus to cause the terminal device to carry out the random access transmission in transmission timings defined by the random access transmission order index parameter and the random access transmission interval parameter.

22. The apparatus of claim 18, wherein the at least one memory and the computer program code are configured, with the at least one processor, to cause the apparatus to cause the terminal device to utilize a first random access identifier in connection with random access transmission; to cause the terminal device to update the random access identifier after the random access transmission, and to cause the terminal device to monitor for random access response message comprising said updated identifier, the random access response message being a response to said random access transmission.

23. The apparatus of claim 12, further comprising radio interface components to provide the apparatus with radio communication capability.

24. A computer program product embodied on a distribution medium readable by a computer and comprising program instructions which, when loaded into an apparatus, execute a computer process comprising:
assigning the same random access parameters concurrently to a plurality of terminal devices of a cellular communication system; and
assigning a different random access transmission opportunity to said plurality of terminal devices so as to multiplex random access transmissions of said plurality of terminal devices, wherein the random access transmission opportunity identifies each one of the plurality of terminal devices using the same random access parameters.

25. A computer program product embodied on a distribution medium readable by a computer and comprising program instructions which, when loaded into an apparatus, execute a computer process comprising:
employing shared random access parameters in a terminal device of a cellular communication system, wherein the same random access parameters are allocated simultaneously to at least one other terminal device;
receiving a random access transmission opportunity allocation according to a defined opportunity and/or order for random access transmission, wherein the random access transmission opportunity is multiplexed with random access transmission opportunities of the at least one other terminal device utilizing said shared random access parameters, and wherein the random access transmission opportunity identifies the terminal device from the at least one other terminal device using the same random access parameters; and
causing the terminal device to carry out a random access transmission according to the received random access transmission opportunity and by using said shared random access parameters.
